(19) United States
(12) Patent Application Publication
(10) Pub. No.: US 2004/0119869 A1
(43) Pub. Date: Jun. 24, 2004

(54) Dual sensor camera

(76) Inventors: Daniel R. Tretter, San Jose, CA (US); D. Amnon Silverstein, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/328,786

(22) Filed: Dec. 24, 2002

(51) Int. Cl. H04N 5/225

(52) U.S. Cl. 348/335

(57) ABSTRACT

A method of operating a camera includes the step of selecting an recording mode of either a still or a video mode. At least one of the optical path or the first and second sensors is configured to communicate the optical signal to a selected one of the first and second sensors in accordance with the recording mode. The viewpoint of the optical path is independent of the recording mode. In various embodiments the first and second sensors are positioned by sliding or pivoting such that the optical signal is incident on the selected sensor. In an alternative embodiment, a mirror re-directs the optical signal to be incident upon the first or second sensor in accordance with the recording mode.

### FIELD OF THE INVENTION

This invention relates to the field of cameras. In particular, this invention is drawn to facilitating the recordation of both image streams and still images.

### BACKGROUND OF THE INVENTION

Traditional cameras or video recorders typically provide a single sensor suitable for recording an image or image stream. A digital camera, for example, may have a single sensor composed of a large number of individual sense elements for capturing a high resolution, static image. A video recorder likewise provides a sensor suitable for recording an image stream. The video recorder sensor is typically lower resolution than the camera's single sensor in order to achieve a pre-determined frame rate.

Although video recorders and digital cameras might permit the user to select different resolutions, the sensors suitable for high resolution camera use are typically not suitable for use in video cameras due to the frame rate requirements of recording an image stream. Similarly, sensors suitable for video camera use are typically not as high resolution as digital camera sensors. Thus the video camera image sensor is unsuitable for recording high resolution static images.

One solution for capturing both still images and videos is to use both a camera and a video recorder. This solution, however, incurs the additional cost of the second piece of equipment as well as the inconvenience of handling two pieces of equipment for photography.

Some video recorders permit the user to operate the video recorder in a “single shot” mode. Alternatively, a static image can be derived from individual frames of an image stream. Due to the lower resolution of the video recorder sensor, the quality or resolution of the selected frame from the image stream is necessarily less than that achievable by the digital camera.

Some dual sensor cameras use separate sensors for video and still images. These cameras also use separate optics. Such a camera will not capture the same scene when operating in a still camera mode versus a video recorder mode due to the different viewpoints of the separate optics associated with each sensor. Moreover the use of separate optics tends to increase the price of the camera significantly.

### SUMMARY OF THE INVENTION

In view of limitations of known systems and methods, various methods and apparatus for recording images in a still or video mode are disclosed.

One embodiment of a camera apparatus includes a first sensor for recording video and a second sensor for recording still images. An optical path is coupled to exclusively communicate an optical signal to a selected one of the first and second sensors in accordance with a recording mode.

In one embodiment, the viewpoint of the optical path is independent of the recording mode of the camera. In one embodiment, exclusive selection of the first and second sensors is accomplished through the use of a pivotable mirror. Exclusive selection of the first or second sensor is accomplished in another embodiment through the use of a pivotable platform carrying the first and second sensors. In yet another embodiment, the first and second sensors are carried by a sliding platform. When the platform or mirror pivots or slides to a first position, the optical signal is incident on the first sensor. When the platform or mirror pivots or slides to the second position, the optical signal is incident on the second sensor.

One method of operating a camera includes the step of selecting an recording mode of either a still or a video mode. At least one of the optical path or the first and second sensors is configured to communicate the optical signal to a selected one of the first and second sensors in accordance with the recording mode. The viewpoint of the optical path is independent of the recording mode.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of a dual sensor camera apparatus with a pivoting mirror for selectively capturing still or video images.

FIG. 2 illustrates an alternative embodiment of a dual sensor camera apparatus with pivotable sensors (shared pivot).

FIG. 3 illustrates an alternative embodiment of a dual sensor camera apparatus with pivotable sensors (individual pivots).

FIG. 4 illustrates an alternative embodiment of a dual sensor camera apparatus with pivotable sensors.

FIG. 5 illustrates an alternative embodiment of a dual sensor camera apparatus with slidable sensors.

FIG. 6 illustrates one embodiment of a method for appropriately selecting sensors of a dual sensor camera apparatus in accordance with the recording mode.

FIG. 7 illustrates a method of reducing artifacts in a recorded video when interrupting a video recording with a still recording.

### DETAILED DESCRIPTION

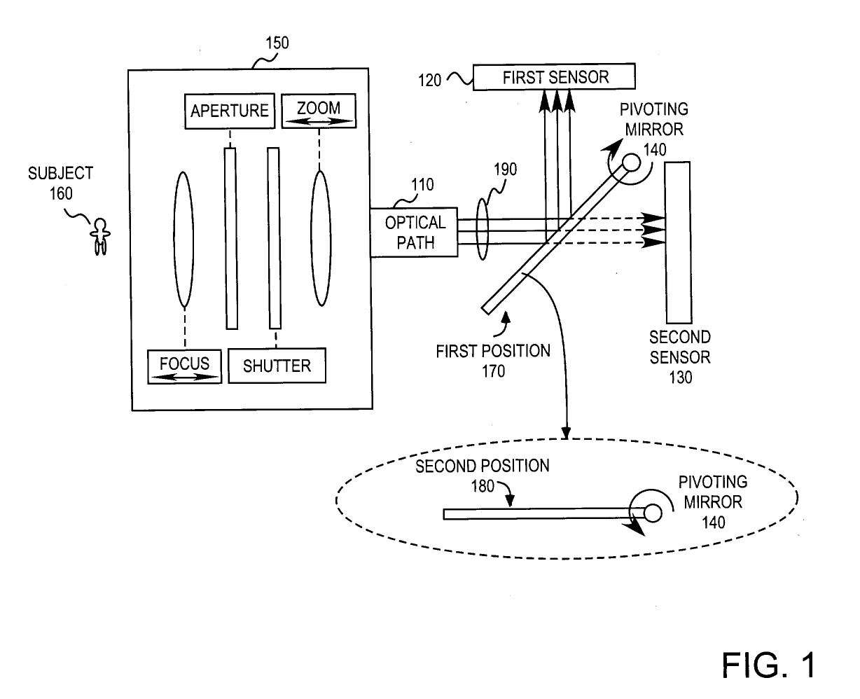

FIG. 1 illustrates one embodiment of a camera apparatus for capturing either still images or videos. Light reflecting or emanating from the subject 160 and subject's surroundings is captured by the optics 150 of the camera as an optical signal. Typically the optics include lenses for focusing and zooming in on the subject as well as an adjustable aperture. The optics may also include a shutter with a variable open time. These optics form a portion of the optical path 110 which communicates the optical signal 190 to a selected one of a first sensor 120 and a second sensor 130.

Although the sensors are designed for visible light applications in one embodiment, other applications may require the use of sensors capable of detecting different portions of the electromagnetic spectrum such as infrared, ultraviolet, etc. Accordingly the term “optical signal” may include portions of the electromagnetic spectrum other than visible light and is not intended to be limited to visible light.

In the illustrated embodiment, the optical signal 190 is incident upon a pivotable mirror 140. When the pivotable mirror is located in first position 170, the optical signal is reflected from the mirror to the first sensor 120 such that the optical signal is incident on the first sensor and not communicated to the second sensor. When the pivotable mirror is located in second position 180, the optical signal is reflected from the mirror to the second sensor such that the optical signal is incident on the second sensor and not communicated to the first sensor. Due to the use of a mirror, the sensors do not share a common selected optical plane.

The first and second sensors are provided for recording video or still images. In one embodiment, the first sensor is for recording video and the second sensor is for recording still images. The second sensor may have substantially greater resolution than the first sensor. Typically, this implies that the second sensor has a substantially greater number of sense elements than the first sensor.

Generally the larger the number of sense elements, the longer the period of time required to read the sensor. As the sense element count increases, the frequency with which the entire array of sense elements can be read (and cleared if necessary) tends to decrease. As a result, large arrays of sense elements are not suitable for video recording if the sense element array cannot be read and cleared with sufficient frequency to maintain a pre-determined video recording frame rate. Given that still images are not subject to a frame rate constraint, high resolution sensors may be used to record still images while lower resolution sensors are used to record videos to ensure that a video frame rate of at least the pre-determined frame rate can be sustained.

In one embodiment mirror 140 comprises a single mirror. In an alternative embodiment, mirror 140 comprises a plurality of mirrors or mirror array. One example of a mirror array is a microelectromechanical system (MEMS) mirror array. Fabrication of such structures on semiconductor substrates is well known.

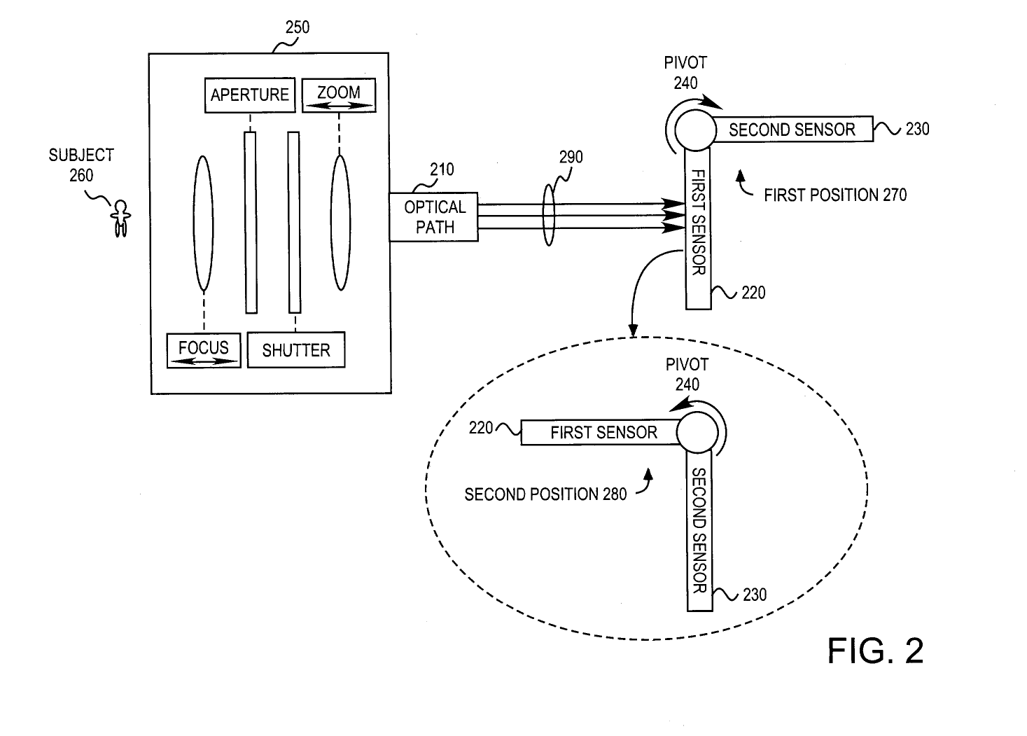

FIG. 2 illustrates an alternative embodiment of a camera apparatus for selectively capturing a still image or a video. Instead of re-directing the optical signal, the sensors are positioned in accordance with the recording mode. Light reflecting or otherwise emanating from subject 260 is captured by the camera optics 250 which form a portion of the optical path 210 that the optical signal 290 travels.

The apparatus includes a pivotable platform 240 carrying the first sensor 220 and the second sensor 230. When the pivotable platform 240 is located in a first position 270, the optical signal 290 is incident on the first sensor 220. When the pivotable platform 240 is located in a second position 280, the optical signal 290 is incident on the second sensor 230. The pivotable platform provides a common selected optical plane for receiving the optical signal by either the first or second sensor.

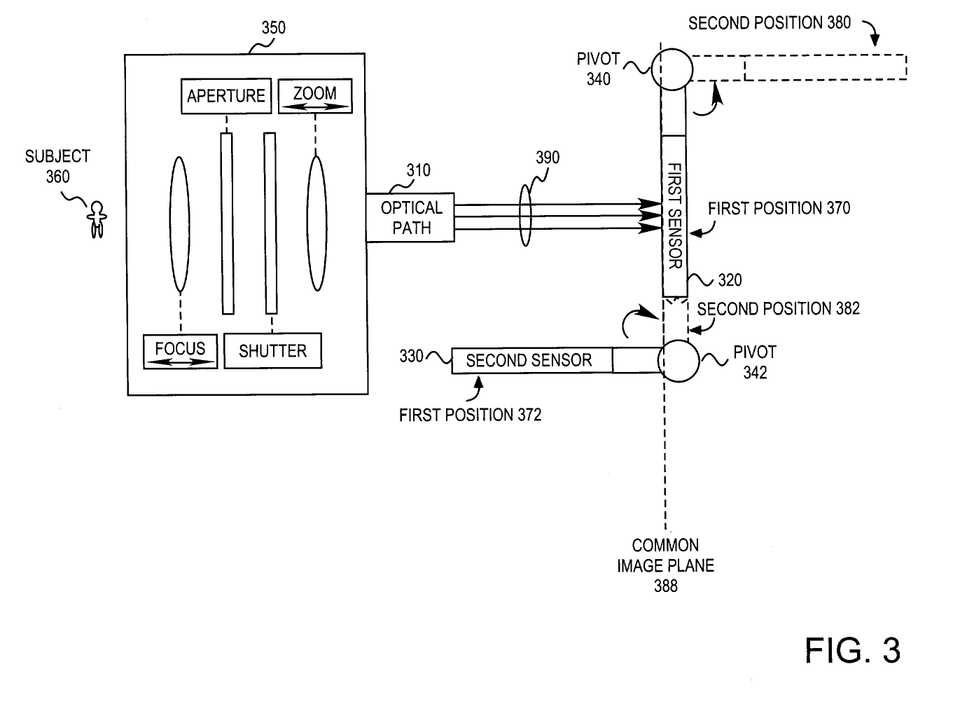

FIG. 3 illustrates an alternative embodiment where the pivotable platform actually consists of two distinct pivots. The first sensor 320 pivots about pivot 340 and the second sensor 330 pivots about pivot 342. Through mechanical design (e.g., linkages) or programming (e.g., firmware), the pivotable platform pivots are operated in a manner to ensure that the optical signal may be incident on only one of the two sensors. When the pivotable platform is in a first configuration, the first sensor is in position 370 and the second sensor is in position 372 such that the optical signal is incident upon first sensor 320 to the exclusion of second sensor 330. When the pivotable platform is in a second configuration, first sensor 320 is in position 380 and the second sensor 330 is in position 382 such that the optical signal is incident upon second sensor 330 to the exclusion of first sensor 320. The first and second sensors share the same image plane 388 albeit not simultaneously. The pivotable platform is thus configured in accordance with the selected recording mode to communicate the optical signal to an exclusive one of the first and second sensors.

In each of the first and second illustrated embodiment, the two sensors are provided with the same viewpoint of the subject due to the use of a single optical path. One end of the optical path and thus the apparent viewpoint of optical signal is independent of the recording mode. This eliminates parallax when switching between sensors. The optical signal is communicated to only one of the first and second sensors in accordance with the image recording or capture mode. Either the sensors are moved as illustrated in FIG. 2, or the optical signal is redirected as illustrated in FIG. 1 to communicate the optical signal to the appropriate sensor in accordance with the recording mode.

A beamsplitter such as a prism or a partially transparent mirror might be used to communicate the optical signal to both sensors simultaneously to avoid pivotably moving components. The signal strength of the resulting optical signal incident on each sensor would be significantly less than the signal strength of the optical signal incident on the selected sensor when the optical signal is not split. Thus exclusive communication of the optical signal to only one of the two sensors at any given time results in better signal quality and tends to provide a better signal-to-noise ratio than the result of communicating the optical signal to both sensors substantially simultaneously through the use of a beamsplitter.

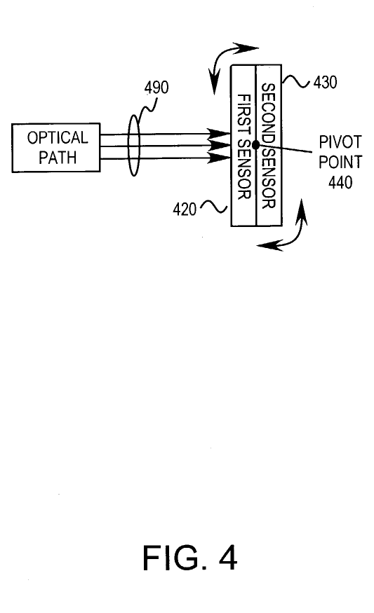

FIG. 4 illustrates an alternative embodiment of dual sensor camera apparatus with pivotable sensors. The sensor platform comprising first sensor 420 and second sensor 430 can be rotated about shared pivot 440. In the first position as illustrated, the optical signal is incident upon first sensor 420. When the sensor assembly is rotated 180°, however, the optical signal is incident upon second sensor 430.

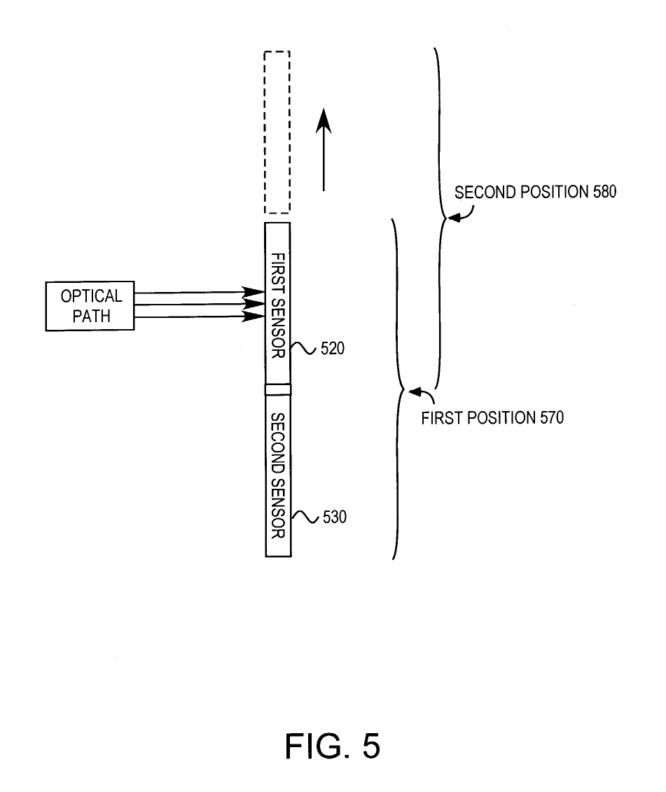

FIG. 5 illustrates an alternative embodiment of a dual sensor camera apparatus with sliding sensors. First sensor 320 and second sensor 330 are located on a platform capable of sliding. In the first position 570 as illustrated, the optical signal is incident upon first sensor 520. When the platform slides to second position 580, the optical signal is incident upon second sensor 530.

One or both of the sensors may be fabricated as integrated circuit sensors. In one embodiment at least one of the sensors is a charge coupled device (CCD). In one embodiment at least one of the sensors is a complementary metal oxide semiconductor (CMOS) sensor.

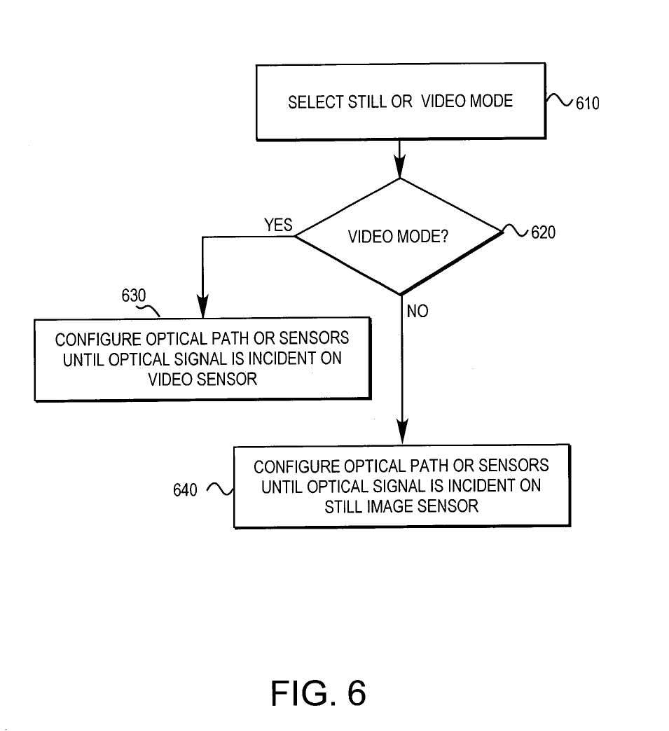

FIG. 6 illustrates a method of operating a dual sensor camera apparatus. The user selects either a still or a video recording mode of operation in step 610. If the user selects video mode as determined by step 620, either the optical path or the sensors are configured to provide the optical signal from a common viewpoint to the video sensor in step 630. If the user selects still image mode, either the optical path or the sensors are configured to provide the optical signal from the common viewpoint to the still image sensor in step 640. Steps 630 and 640 may be accomplished in various embodiments by either 1) re-directing the optical signal, or 2) re-positioning the sensors.

The mechanism for mode selection may be positioned to enable the user to toggle between still and video mode without changing viewpoints. In particular, the user may choose to interrupt a video mode of recording to capture a still image. An interruption, however, would likely result in the loss of a couple of frames of the video thus resulting in some artifacts or discontinuity of the video in the absence of further processing.

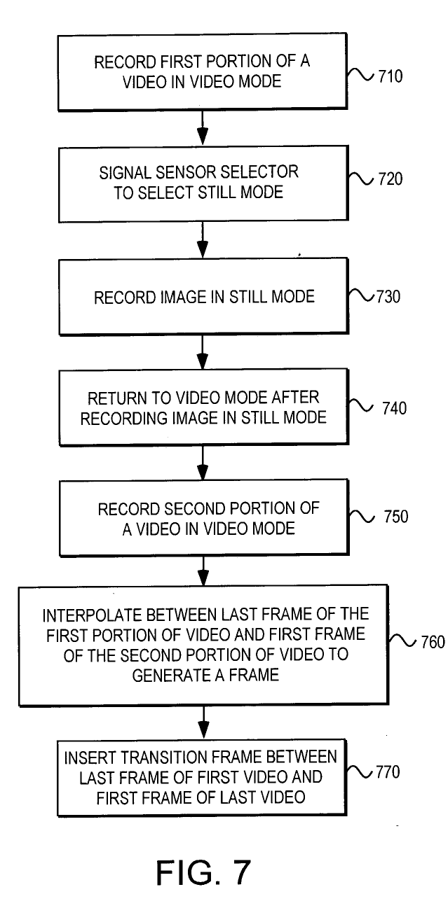

FIG. 7 illustrates a method of handling interrupted video when toggling between recording modes. The user is operating the camera apparatus in a video recording mode in step 710 to capture a first portion of a video. The user signals a sensor selector to select the still sensor in step 720. The still sensor records an image in step 730. The sensor selector automatically selects the video sensor in step 740 after the still sensor has captured an image in step 730. The video sensor captures a second portion of a video in 750.

There is a loss of continuity between the last frame of the first portion of video and the first frame of the second portion of video due to the interrupting use of the still sensor. The loss of continuity is effectively a loss of information. The information may be synthesized to reduce the visual effect of the discontinuity.

In step 760, a transition frame is generated by interpolation of the last and first frames of the first and second video portions, respectively. Alternatively, the transition frame may be generated by interpolation of a combination of the last and first frames of the first and second video portions, respectively, and the image captured with the still sensor. The transition frame is inserted between the last frame of the first video and the first frame of the second video in step 770.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method of operating a camera comprising the steps of:
a) selecting one of a still and a video image recording mode; and
b) communicating an optical signal from a common viewpoint to an exclusive selected one of a first sensor for recording video and a second sensor for recording still images in accordance with the selected recording mode.

2. The method of claim 1 wherein step b) further comprises the step of pivoting a pivotable mirror to one of a first position and a second position in accordance with the selected recording mode, wherein the optical signal is incident on the first sensor when the pivotable mirror is in the first position, wherein the optical signal is incident on the second sensor when the pivotable mirror is in the second position

3. The method of claim 1 wherein the first and second sensors are located on a pivotable platform, wherein step b) further comprises the step of pivoting the pivotable platform to one of a first position and a second position in accordance with the selected recording mode, wherein the optical signal is incident on the first sensor when the pivotable platform is in the first position, wherein the optical signal is incident on the second sensor when the pivotable platform is in the second position.

4. The method of claim 1 wherein the first sensor pivots about a first pivot, wherein the second sensor pivots about a second pivot, wherein step b) further comprises the step of pivoting each of the first and second sensors to an one of a first position and a second position in accordance with the selected recording mode, wherein the optical signal is incident on the first sensor when the first sensor is in the first position, wherein the optical signal is incident on the second sensor when the second sensor is in the second position.

5. The method of claim 1 wherein step b) further comprises the steps of:
i) sliding the first and second sensors to a first position if a video mode is selected, wherein the optical signal is incident upon the first sensor, wherein the optical signal is not incident upon the second sensor; and
ii) sliding the first and second sensors to a second position if a still image mode is selected, wherein the optical signal is incident upon the second sensor, wherein the optical signal is not incident upon the first sensor.

6. The method of claim 1 wherein a resolution of the second sensor is substantially greater than a resolution of the first sensor.

7. The method of claim 1 wherein the second sensor has a substantially greater number of sense elements than the first sensor.

8. The method of claim 1 wherein at least one of the first and second sensors is a complementary metal oxide semiconductor (CMOS) sensor.

9. The method of claim 1 wherein at least one of the first and second sensors is a charge coupled device.

10. A camera apparatus, comprising:
a first sensor for recording video;
a second sensor for recording still images; and
an optical path coupled to exclusively communicate an optical signal to a selected one of the first and second sensors in accordance with a recording mode.

11. The apparatus of claim 10 further comprising:
a pivotable mirror, wherein the pivotable mirror communicates the optical signal from the optical path to the first sensor when pivoted to a first position, wherein the pivotable mirror communicates the optical signal from the optical path to the second sensor when pivoted to a second position.

12. The apparatus of claim 10 further comprising:
a pivotable mirror array comprising a plurality of pivotable mirrors, wherein the pivotable mirror array communicates the optical signal to the first sensor when the plurality of pivotable mirrors are pivoted to a first position, wherein the pivotable mirror array communicates the optical signal to the second sensor when the plurality of pivotable mirrors are pivoted to a second position.

13. The apparatus of claim 10 further comprising:
a pivotable platform carrying the first and second sensors, wherein the optical signal is incident upon the first sensor when the pivotable platform is pivoted to a first position, wherein the optical signal is incident upon the second sensor when the pivotable platform is pivoted to a second position.

14. The apparatus of claim 10 wherein at least one of the first and second sensors is a semiconductor optical sensor.

15. The apparatus of claim 10 wherein at least one of the first and second sensors is a complementary metal oxide semiconductor (CMOS) sensor.

16. The apparatus of claim 10 wherein at least one of the first and second sensors is a charge coupled device.

17. A camera apparatus, comprising:
a first sensor for recording video;
a second sensor for recording still images; and
an optical path wherein at least one of the optical path and the first and second sensors is configured to communicate an optical signal to a selected one of the first and second sensors in accordance with a recording mode, wherein a viewpoint of the optical path is independent of the recording mode.

18. The apparatus of claim 17 further comprising:
a pivotable mirror, wherein the pivotable mirror communicates the optical signal from the optical path to the first sensor when pivoted to a first position, wherein the pivotable mirror communicates the optical signal from the optical path to the second sensor when pivoted to a second position.

19. The apparatus of claim 17 further comprising:
a pivotable platform carrying the first and second sensors, wherein the optical signal is incident upon the first sensor when the pivotable platform is pivoted to a first position, wherein the optical signal is incident upon the second sensor when the pivotable platform is pivoted to a second position.

20. The apparatus of claim 17 further comprising a sliding platform carrying the first and second sensors, wherein the optical signal is incident upon the first sensor when the sliding platform is located in a first position, wherein the optical signal is incident upon the second sensor when the sliding platform is located in a second position.
